(19) United States
(12) Patent Application Publication
(10) Pub. No.: US 2018/0225163 A1
(43) Pub. Date: Aug. 9, 2018

(54) CUSTOM CONNECTOR FOR PLATFORMS

(71) Applicant: FinancialForce.com, inc., San Francisco, CA (US)

(72) Inventor: Alba AZCONA RIVAS, San Francisco, CA (US)

(21) Appl. No.: 15/824,018

(22) Filed: Nov. 28, 2017

Related U.S. Application Data
(60) Provisional application No. 62/454,182, filed on Feb. 3, 2017.

(51) Int. Cl. G06F 9/54; H04L 29/08

(52) U.S. Cl. CPC G06F 9/548; G06F 17/30386; H04L 67/02

(57) ABSTRACT

A custom connector can translate a request for data in one protocol from one platform into a request using another protocol used by a second platform. The custom connector can then generate a listing of the results of the request in accordance with an affinity algorithm that weights votes ranking the results differently based on similar votes.

### CLAIM FOR PRIORITY

This application claims priority to U.S. Provisional Patent Application No. 62/454,182, entitled “Custom Connector for Platforms,” by Azcona Rivas, and filed on Feb. 3, 2017. The content of the above-identified application is incorporated herein by reference in its entirety.

### TECHNICAL FIELD

This disclosure relates to connecting platforms, and in particular using a custom connector to connect platforms.

### BACKGROUND

Cloud platforms such as the SALESFORCE platform (provided by Salesforce.com, Inc.) allow for sharing processing resources and data in a multi-tenant network that offers computing services on demand to customers. Cloud computing enables ubiquitous, on-demand access to a shared pool of configurable computing resources (e.g., networks, servers, storage, applications, and services), which can be rapidly provisioned and released with minimal management effort. For example, the SALESFORCE platform can provide numerous companies with an environment to deploy applications.

In some situations, an application might benefit from using resources of the SALESFORCE platform with resources of other platforms.

### SUMMARY

Some of the subject matter described herein includes a method, comprising: receiving a first request for data to be provided to a first platform from a second platform, the request being in a first protocol, the first platform and the second platform being different platforms, the first platform providing functionality configured to use data stored within the second platform; translating, by a processor, the first request into a second request in a second protocol used by the second platform, the first protocol and the second protocol being different; providing the second request to the second platform; receiving results providing the data corresponding to the second request from the second platform; and generating a listing of the results based on an affinity algorithm weighting votes ranking the results provided by users of the first platform, users providing similar votes having a different weighting than users providing different votes.

In some implementations, the second request uses an application programming interface (API) of the second platform.

In some implementations, the first request is in a database query format, and the second request is in a hypertext transfer protocol format.

In some implementations, the results are in a format providing attribute-value pairs for the data.

In some implementations, the method includes generating a data object corresponding to the results in a data format used by the first platform, wherein the listing of the results is based on the data object.

In some implementations, the data format is a database table.

In some implementations, the first request includes a geographic location of a user corresponding to the first request.

Some of the subject matter described herein also includes an electronic device, comprising: one or more processors; and memory storing instructions, wherein the processor is configured to execute the instructions such that the processor and memory are configured to: receive a first request for data to be provided to a first platform from a second platform, the request being in a first protocol, the first platform and the second platform being different platforms, the first platform providing functionality configured to use data stored within the second platform; translate the first request into a second request in a second protocol used by the second platform, the first protocol and the second protocol being different; provide the second request to the second platform; receive results providing the data corresponding to the second request from the second platform; and generate a listing of the results based on an affinity algorithm weighting votes ranking the results provided by users of the first platform, users providing similar votes having a different weighting than users providing different votes.

In some implementations, the second request uses an application programming interface (API) of the second platform.

In some implementations, the first request is in a database query format, and the second request is in a hypertext transfer protocol format.

In some implementations, the results are in a format providing attribute-value pairs for the data.

In some implementations, the processor is configured to execute the instructions such that the processor and memory are configured to: generate a data object corresponding to the results in a data format used by the first platform, wherein the listing of the results is based on the data object.

In some implementations, the data format is a database table.

In some implementations, the first request includes a geographic location of a user corresponding to the first request.

Some of the subject matter described herein also includes a computer program product, comprising one or more non-transitory computer-readable media having computer program instructions stored therein, the computer program instructions being configured such that, when executed by one or more computing devices, the computer program instructions cause the one or more computing devices to: receive a first request for data to be provided to a first platform from a second platform, the request being in a first protocol, the first platform and the second platform being different platforms, the first platform providing functionality configured to use data stored within the second platform; translate the first request into a second request in a second protocol used by the second platform, the first protocol and the second protocol being different; provide the second request to the second platform; receive results providing the data corresponding to the second request from the second platform; and generate a listing of the results based on an affinity algorithm weighting votes ranking the results provided by users of the first platform, users providing similar votes having a different weighting than users providing different votes.

In some implementations, the second request uses an application programming interface (API) of the second platform.

In some implementations, the first request is in a database query format, and the second request is in a hypertext transfer protocol format.

In some implementations, the results are in a format providing attribute-value pairs for the data.

In some implementations, the computer program instructions cause the one or more computing devices to: generate a data object corresponding to the results in a data format used by the first platform, wherein the listing of the results is based on the data object.

In some implementations, the data format is a database table.

### BRIEF DESCRIPTION OF THE DRAWINGS

FIG. 1 illustrates an example of using a custom connector.

FIG. 2 illustrates an example of a block diagram for using a custom connector.

FIGS. 3-5 illustrate examples of an application using the custom connector.

FIG. 6 is a block diagram illustrating a computer operable to implement the disclosed technology according to some embodiments of the present disclosure.

### DETAILED DESCRIPTION

The embodiments set forth below represent the necessary information to enable those skilled in the art to practice the embodiments, and they illustrate the best mode of practicing the embodiments. Upon reading the following description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing the embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices.

As used herein, terms such as “connected,” “coupled,” or the like, refer to any connection or coupling, either direct or indirect, between two or more elements. The coupling or connection between the elements can be physical, logical, or a combination thereof.

This disclosure describes devices and techniques for a custom connector for platforms. In one example, a custom connector can be used to receive data from one platform for use within another platform. The different platforms (or software or computing platforms) can store different types of data, provide different functionalities, be provided by different services and/or servers (e.g., by different vendors), etc. This can include the custom connector translating a request for data provided by the first platform from one protocol into another protocol used by the other platform. The translated request can then be provided to the other, second platform by the custom connector. The results of the request as provided by the second platform can then be received by the custom connector. The custom connector can then generate a data object including the results that can be used by the first platform. Thus, the custom connector can allow different platforms to be used for a particular application.

For example, for one application, a first platform can include a database of commercial businesses such as restaurants. A second platform can include functionality such as providing the capability to rate the restaurants and request a listing of the restaurants within close geographic proximity to a user making a request for local restaurants. Thus, different types of data and functionalities are available for a developer at the different platforms. The second platform can provide a request to the first platform for a listing of the local restaurants via the custom connector that can translate between different protocols used by the different platforms. The listing of restaurants can then be provided to the user to view. Additionally, the user can rate the restaurants. In some implementations, an affinity algorithm can be used to recommend restaurants to the user based on the user's votes and the votes of other users. Thus, the data from the first platform can be used by the second platform to view and rate the different restaurants.

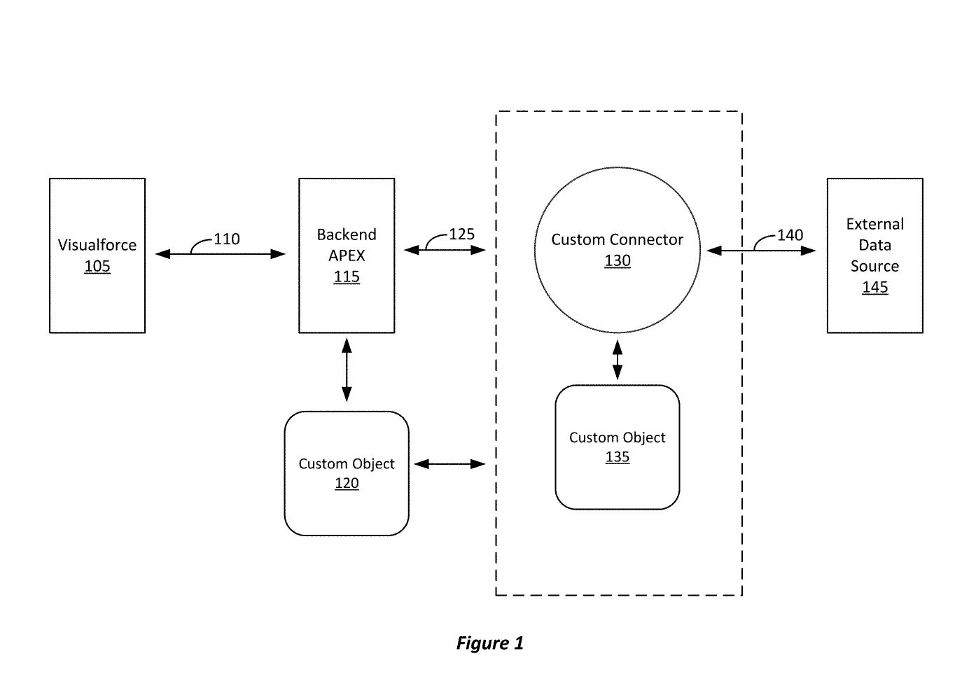

In more detail, FIG. 1 illustrates an example of using a custom connector. In FIG. 1, visualforce page 105 can be a service offered by a platform such as SALESFORCE that can, in one example, provide a user with the capability to view and review restaurants within a close geographic proximity of the user's current location. For example, visualforce page 105 can be part of one platform that can include a user login (e.g., requesting a login and password as authentication credentials) that can be used to provide the viewing and reviewing of restaurants, businesses, services, etc. External data source 145 can be another platform, for example, Google Places, that can include a database of locations, for example, restaurants. These two platforms (represented by visual force page 105 as one platform and external data source 145 as another platform) can be used together via customer connector 130. Thus, different resources of different platforms can be used together with custom connector 130 in FIG. 1. This can allow for a quick and efficient way to use the resources of different platforms to create more complicated functionalities for users.

For example, in FIG. 1, a user can log into visualforce page 105, which can include a website with a username and password login as a form of user authentication (e.g., to ensure that an authorized user is logging into the system) provided by the SALESFORCE platform. When the user logs in, visualforce page 105 can determine the user's location via a variety of location identification techniques such as a javascript geolocation function that can be implemented by visualforce page 105. This location information can then be provided 110 to backend APEX 115.

Backend APEX 115 can be another resource of the same platform as visualforce page 105 that provides the functionality of a controller for receiving from and providing data to visualforce page 105. In some implementations, the data provided 110 by visualforce page 110 can include a function call. For example, visualforce page 105 can instruct backend APEX 115 to perform a particular function, for example, a function such as “by distance” which can also be accompanied with the geographic location of the user (e.g., latitude and longitude coordinates, global positioning satellite (GPS) coordinates, etc. that indicate a location of the user). The function “by distance” accompanied with the user's geographic location can indicate that visualforce page 105 wishes to receive a listing of locations (e.g., restaurants) from external data source 145 that are within close geographic proximity to the user (e.g., within five miles, within ten kilometers, etc.). Thus, visualforce page 105 can provide an instruction to backend APEX 115 to perform some functionality (e.g., receive a listing of locations) using some data (e.g., the geographic location of the user).

Backend APEX 115 can be implemented via Apex, which is a strongly typed object-oriented programming language. Backend APEX 115 can generate a Salesforce Object Query Language (SOQL) query as a request based on the data received from visualforce page 105. This can be useful because visualforce page 105 might be developed via Javascript and therefore its providing 110 of data can be in a different format or protocol. The SOQL query can be in the form of a database query indicating that locations within the close proximity of the user be provided. Thus, backend APEX can provide 125 the SOQL query to customer connector 130.

Custom connector 130 can receive the SOQL request and translate it into another format or protocol that is used by external data source 145. For example, custom connector 130 can translate the SOQL request into a representational state transfer (REST) Hypertext Transfer Protocol (HTTP) request to be provided 140 to external data source 145. In some implementations, this can be via an application programming interface (API) of external data source 145. That is, the HTTP request can utilize the API of external data source 145 that allows other platforms to request and receive data using the API.

The REST HTTP request can include data such that external data source 145 provides back results corresponding to the SOQL request, for example, the locations within close proximity to the user. In some implementations, the data provided by external data source 145 back to custom connector 130 can be in the form of JavaScript Object Notation (JSON), which provides human-readable text in a file format including attribute-value pairs with array data types. An attribute-value pair is a data representation in which an attribute (e.g., location) and value (e.g., location name) can be used to provide a listing of locations (e.g., restaurants) to the user. External data source 145 might use a different protocol because it is provided by a different platform, for example, Google Places, in comparison to the platform of visualforce page 105. The different platforms might process data differently, including expecting data to be formatted in particular ways, requests to be provided specific ways, etc.

Thus, custom connector 130 can receive the list of locations from external data source 145, which can include a larger list of locations, as previously discussed. For example, the list of locations provided back to custom connector 130 can be a smaller subset of the locations stored by external data source, for example, the locations within close geographic proximity of the user as determined by visualforce page 105 when the user first logged into the platform. Because external data source 145 is used by another platform than the platform of visualforce page 105, custom connector 130 can handle translations between protocols and store the data received from external data source 130 in a format useful for visualforce page 105 and backend APEX 115.

For example, using custom object 135, custom connector 130 can store the JSON data received from external data source 145 in a format useful to the platform of visualforce page 105 and backend APEX 115. For example, custom object 135 can include data that indicates that each listing of location (e.g., each unique restaurant) be provided with a unique identifier (ID), name, location, rating, photo depicting the location, etc. Custom connector 130 can parse the attribute-value pairs of the JSON data received by external data source 145 and store the parsed data in a format in accordance with custom object 135. In some implementations, custom object 135 might indicate that the JSON data is to be stored in a table of a database with columns for each corresponding attribute-value pair. The database can be a multi-tenant database of the platform that provides visualforce page 105 and backend APEX 115.

For example, name, location, photo, etc. can each be an attribute with a corresponding value of the attribute-value pair indicated in the JSON data received. Thus, custom object 135 can indicate that a table with a name of “restaurants” and having columns “name,” “location,” and “photo” be used to store the JSON data received. Each row of the table can include the attribute-value pair for different locations (e.g., different restaurants).

In some implementations, backend APEX 115 can also use custom object 120 to implement an affinity algorithm. For example, if custom connector 130 is receiving locations of restaurants from external data source 145, then custom object 120 can be used by backend APEX 115 to implement a voting algorithm where the user can vote regarding how they enjoyed a restaurant. For example, the user can provide a score between 1-5 with 1 being a lower review than a 5. Thus, the first platform (e.g., corresponding to visualforce page 105) can implement functionality to allow the user to associate a score with each of the locations received from the second platform (e.g., external data source 145). The restaurants can then be ordered in a list in accordance with the user's score. For example, higher rated restaurants can be displayed higher in a list than lower rated restaurants, and vice versa.

In some implementations, the affinity algorithm implemented using custom object 120 can be based on the user's votes as well as the votes of other users. For example, for users that have given similar or same votes as the user for the same restaurant, their votes can be weighted higher than the votes of other users. For example, if a first restaurant is voted by the user as a 3 (in terms of its rating), and another user has voted that same restaurant as a 3, then that user can earn three points in an affinity score. Other users that voted a rating other than a three can earn a single point in an affinity score. How others voted on other restaurants that the user has also voted on can also be used to generate an affinity score. The affinity score can thus be an aggregation of all of the three or single point scores of the users. The final affinity score can be used to weight the votes of the users and influence the ordering of the restaurants provided using the affinity algorithm. Thus, users providing similar votes can have a different weighting than users providing different votes for the restaurants.

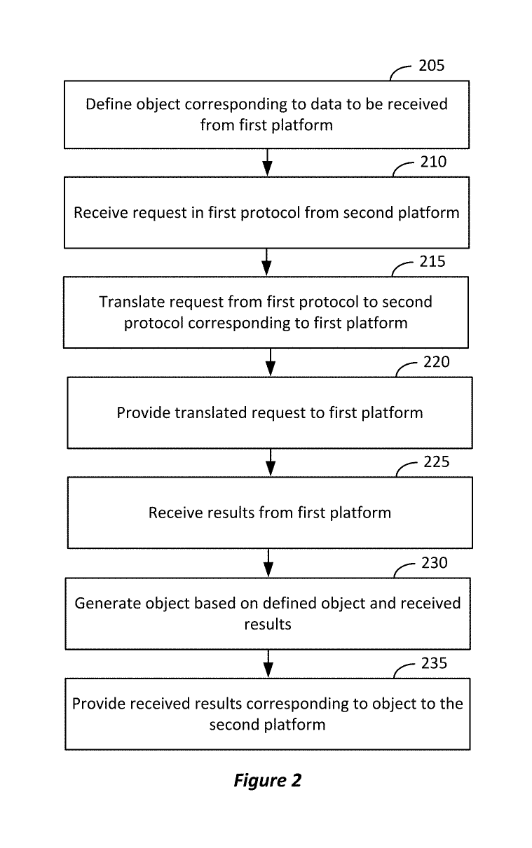

FIG. 2 illustrates an example of a block diagram for using a custom connector. FIG. 2 illustrates an example of a block diagram for using a custom connector. In FIG. 2, at block 205, an object corresponding to data received from a first platform can be defined. For example, “Restaurant_x” can be defined as an object for storing data received from Google Places via an API. This object can be a database with columns for storing data received from the external data source. For example, using the example of restaurants, the object can store a unique identifier for each restaurant, name, location, latitude, longitude, rating, photo, etc.

At block 210, the custom connector can receive a request in a first protocol from a second platform. For example, a request can be received from the visualforce page by the backend APEX logic that can implement a visualforce controller. As discussed above, the request can be received as a SOQL query.

At block 215, the request can be translated from a first protocol to a second protocol corresponding to the first platform. For example, if the request is a SOQL query, then the controller can translate that to an HTTP request to be provided to Google Places (using the API) as previously discussed.

At block 220, the translated request can be provided to the first platform. For example, the HTTP request can be provided to Google Places. At block 225, the controller can receive the results from the first platform. For example, the results from Google Places can be received, for example, in the JSON format as discussed above.

At block 230, an object can be generated based on the definition of the object and the received results. For example, an object of type “Restaurant_x” can be generated. For example, this can include generating a row within a database table as indicated by the object. The data received in the JSON request can be stored in memory as attributes of the object (e.g., a unique identifier for each restaurant, name, location, latitude, longitude, rating, photo, etc.).

At block 235, the results can be provided to the second platform. For example, the results from the object of the type “Restaurant x” can be provided to the visualforce page.

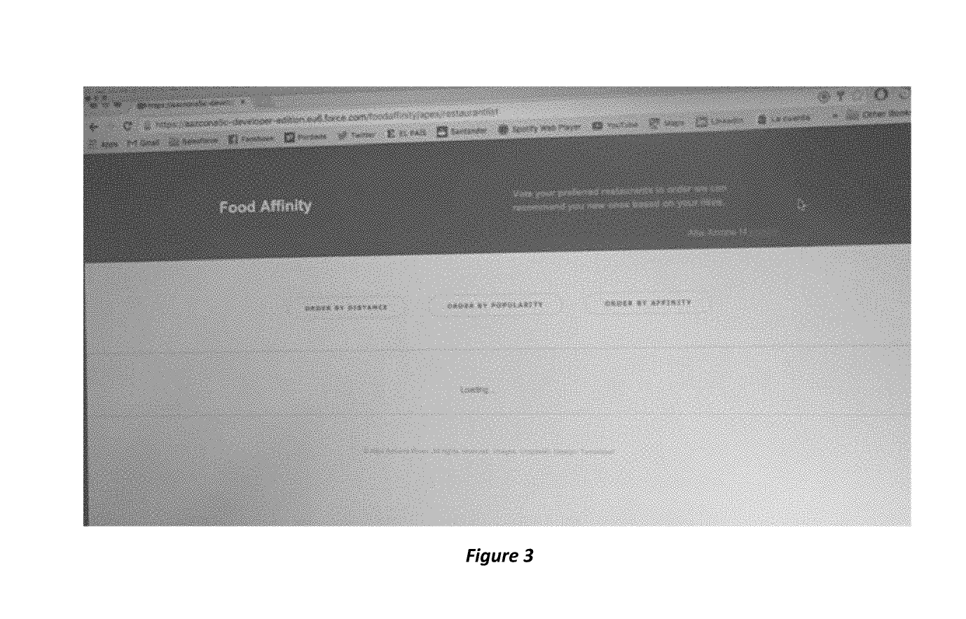

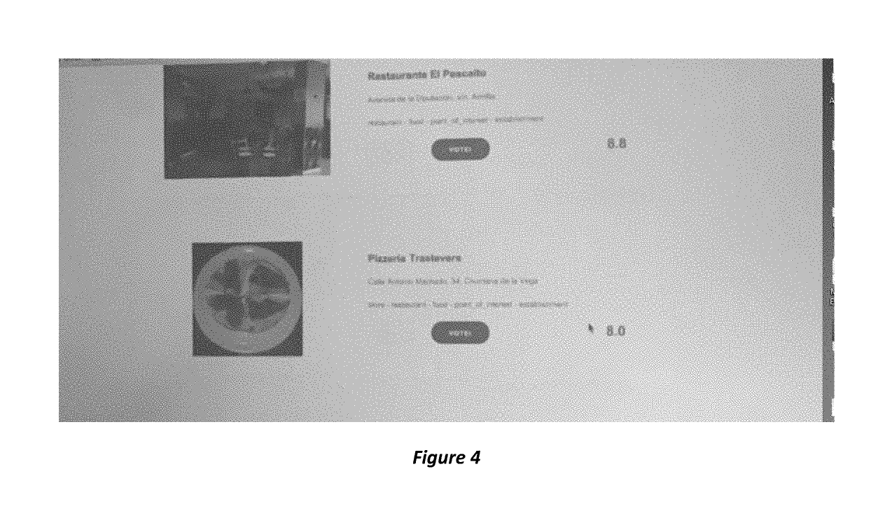

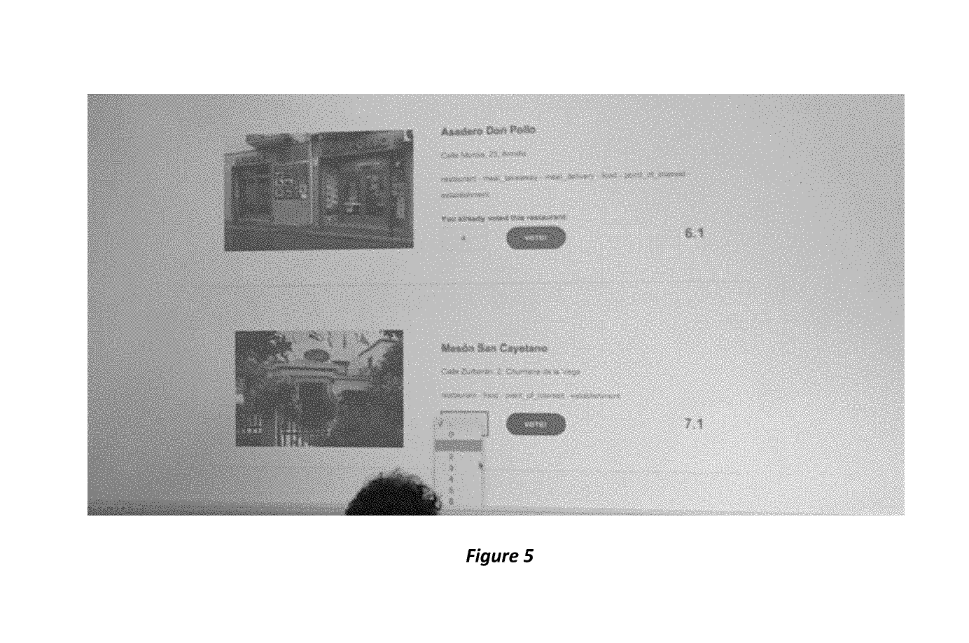

In some implementations, the user can view the results from the external data source using the platform of the visualforce page by ordering the items (e.g., restaurants or other businesses or locations) by distance from the user (e.g., descending order from the location closer to the user to the location farthest from the user), popularity (e.g., by how other users and possibly the user as well has voted or ranked the restaurant), or by affinity (e.g., using the affinity algorithm as previously discussed). These options are depicted in FIG. 3. When one of the options is selected, the request can be formed by the first platform, provided to the custom connector, translated into the protocol or formatting of the second platform. The results can then be provided and processed as previously discussed. In FIG. 4, the results of requesting the listing of locations in terms of descending vote or review (e.g., a score of 1-10) is listed. If the user wants to contribute to the affinity algorithm to receive more tailored ratings for the locations, the user can select a rating to provide a location, as indicated in FIG. 5.

In some implementations, such as when developing for the SALESFORCE platform, external data source 145 can be defined as an External Object, and custom connector 130 can be defined using Lightning Connect, or SALESFORCE Connect.

Many of the aforementioned examples describe a platform allowing a user to view close by restaurants. However, in other examples, other types of functionality can be provided. For example, the user can be allowed to view other types of businesses and/or services. In another example, a listing might not be provided. Rather, other types of functionality, for example, graphics, charts, etc. can be provided.

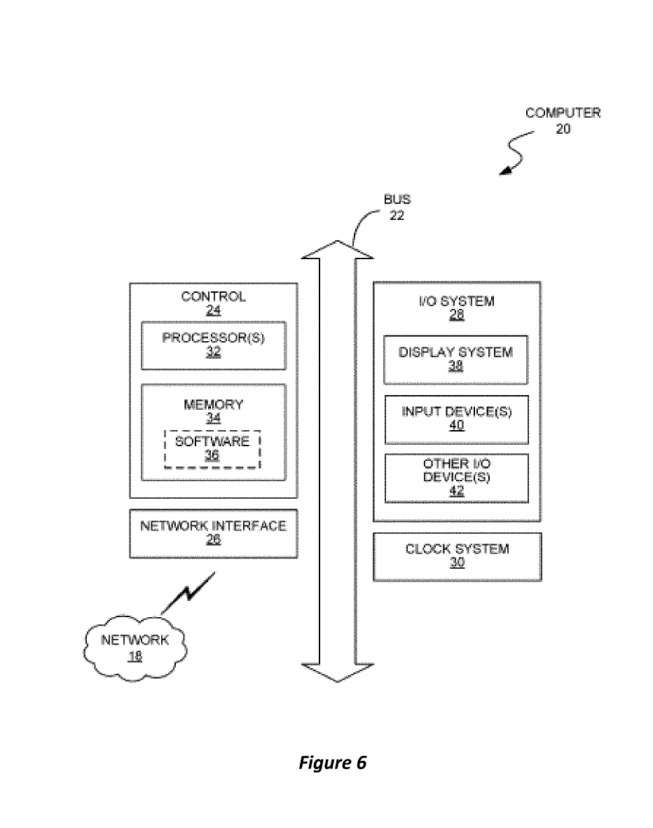

FIG. 6 is a block diagram illustrating a computing device operable to implement the disclosed technology according to some embodiments of the present disclosure. As shown, a computer 32 includes a bus 34 that is operable to transfer data between hardware components. These components include a control 36 (e.g., processing system), a network interface 38, an input/output (I/O) system 40, and a clock system 42. The computing device 32 may include other components that are not shown nor further discussed for the sake of brevity. One having ordinary skill in the art will understand any hardware and software that is included but not shown in FIG. 18.

The control 36 includes one or more processors 44 (e.g., central processing units (CPUs), application specific integrated circuits (ASICs), and/or field programmable gate arrays (FPGAs), and memory 46 (which may include software 48). For example, the memory 46 may include volatile memory, such as random-access memory (RAM) and/or non-volatile memory, such as read-only memory (ROM). The memory 46 can be local, remote, or distributed.

A software program (e.g., software 48), when referred to as “implemented in a computer-readable storage medium,” includes computer-readable instructions stored in the memory (e.g., memory 46). A processor (e.g., processor 44) is “configured to execute a software program” when at least one value associated with the software program is stored in a register that is readable by the processor. In some embodiments, routines executed to implement the disclosed embodiments may be implemented as part of operating system (OS) software (e.g., Microsoft Windows® and Linux®) or a specific software application, component, program, object, module, or sequence of instructions referred to as “computer programs.”

As such, the computer programs typically comprise one or more instructions set at various times in various memory devices of a computer (e.g., computing device 32), which, when read and executed by at least one processor (e.g., processor 44), will cause the computer to perform operations to execute features involving the various aspects of the disclosed embodiments. In some embodiments, a carrier containing the aforementioned computer program product is provided. The carrier is one of an electronic signal, an optical signal, a radio signal, or a non-transitory computer-readable storage medium (e.g., memory 46).

Network interface 38 may include a modem or other interfaces (not shown) for coupling the computing device 32 to other computers over the network 18. The I/O system 40 may operate to control various I/O devices, including peripheral devices such as a display system 50 (e.g., a monitor or touch-sensitive display) and one or more input devices 52 (e.g., a keyboard and/or pointing device). Other I/O devices 54 may include, for example, a disk drive, printer, scanner, or the like. Lastly, the clock system 42 controls a timer for use by the disclosed embodiments.

Operation of a memory device (e.g., memory 46), such as a change in state from a binary one (1) to a binary zero (0) (or vice versa) may comprise a visually perceptible physical change or transformation. The transformation may comprise a physical transformation of an article to a different state or thing. For example, a change in state may involve accumulation and storage of charge or a release of stored charge. Likewise, a change of state may comprise a physical change or transformation in magnetic orientation or a physical change or transformation in molecular structure, such as a change from crystalline to amorphous or vice versa.

Aspects of the disclosed embodiments may be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

While embodiments have been described in the context of fully functioning computers, those skilled in the art will appreciate that the various embodiments are capable of being distributed as a program product in a variety of forms and that the disclosure applies equally, regardless of the particular type of machine or computer-readable media used to actually effect the embodiments.

While the disclosure has been described in terms of several embodiments, those skilled in the art will recognize that the disclosure is not limited to the embodiments described herein and can be practiced with modifications and alterations within the spirit and scope of the invention. Those skilled in the art will also recognize improvements to the embodiments of the present disclosure. All such improvements are considered within the scope of the concepts disclosed herein. Thus, the description is to be regarded as illustrative instead of limiting.

I/We claim:

1. A method comprising:
receiving a first request for data to be provided to a first software platform from a second software platform, the first request being in a first protocol, the first platform and the second software platform being different software platforms providing different services and data, the first software platform providing functionality configured to use data stored within the second software platform;
translating, by a processor, the first request into a second request in a second protocol used by the second software platform, the first protocol and the second protocol being different;
providing the second request to the second software platform;
receiving results providing the data corresponding to the second request from the second software platform; and
generating a listing of the results based on an affinity algorithm weighting votes ranking the results provided by users of the first software platform, users providing similar votes having a different weighting than users providing different votes.

2. The method of claim 1, wherein the second request uses an application programming interface (API) of the second software platform.

3. The method of claim 1, wherein the first request is in a database query format, and the second request is in a hypertext transfer protocol format.

4. The method of claim 3, wherein the results are in a format providing attribute-value pairs for the data.

5. The method of claim 1, further comprising:
generating a data object corresponding to the results in a data format used by the first platform, wherein the listing of the results is based on the data object.

6. The method of claim 5, wherein the data format is a database table.

7. The method of claim 1, wherein the first request includes a geographic location of a user corresponding to the first request.

8. An electronic device, comprising:
one or more processors; and
memory storing instructions, wherein the processor is configured to execute the instructions such that the processor and memory are configured to:
receive a first request for data to be provided to a first platform from a second platform, the request being in a first protocol, the first platform and the second platform being different platforms, the first platform providing functionality configured to use data stored within the second platform;
translate the first request into a second request in a second protocol used by the second platform, the first protocol and the second protocol being different;
provide the second request to the second platform;
receive results providing the data corresponding to the second request from the second platform; and
generate a listing of the results based on an affinity algorithm weighting votes ranking the results provided by users of the first platform, users providing similar votes having a different weighting than users providing different votes.

9. The electronic device of claim 8, wherein the second request uses an application programming interface (API) of the second platform.

10. The electronic device of claim 8, wherein the first request is in a database query format, and the second request is in a hypertext transfer protocol format.

11. The electronic device of claim 10, wherein the results are in a format providing attribute-value pairs for the data.

12. The electronic device of claim 8, wherein the processor is configured to execute the instructions such that the processor and memory are configured to:
generate a data object corresponding to the results in a data format used by the first platform, wherein the listing of the results is based on the data object.

13. The electronic device of claim 12, wherein the data format is a database table.

14. The electronic device of claim 8, wherein the first request includes a geographic location of a user corresponding to the first request.

15. A computer program product, comprising one or more non-transitory computer-readable media having computer program instructions stored therein, the computer program instructions being configured such that, when executed by one or more computing devices, the computer program instructions cause the one or more computing devices to:
receive a first request for data to be provided to a first platform from a second platform, the request being in a first protocol, the first platform and the second platform being different platforms, the first platform providing functionality configured to use data stored within the second platform;
translate the first request into a second request in a second protocol used by the second platform, the first protocol and the second protocol being different;
provide the second request to the second platform;
receive results providing the data corresponding to the second request from the second platform; and
generate a listing of the results based on an affinity algorithm weighting votes ranking the results provided by users of the first platform, users providing similar votes having a different weighting than users providing different votes.

16. The computer program product of claim 15, wherein the second request uses an application programming interface (API) of the second platform.

17. The computer program product of claim 15, wherein the first request is in a database query format, and the second request is in a hypertext transfer protocol format.

18. The computer program product of claim 17, wherein the results are in a format providing attribute-value pairs for the data.

19. The computer program product of claim 15, wherein the computer program instructions cause the one or more computing devices to:
generate a data object corresponding to the results in a data format used by the first platform, wherein the listing of the results is based on the data object.

20. The computer program product of claim 19, wherein the data format is a database table.
